(19) United States
(12) Patent Application Publication
(10) Pub. No.: US 2026/0323631 A1
(43) Pub. Date: Oct. 15, 2026

(54) SIMULTANEOUS TRANSMISSION ON MULTI-PANEL USER EQUIPMENT (UE)

(71) Applicant: Apple Inc., Cupertino, CA (US)

(72) Inventors: Seyed Ali Akbar Fakoorian, San Diego, CA (US); Chunxuan Ye, San Diego, CA (US); Dawei Zhang, Saratoga, CA (US); Yushu Zhang, Beijing (CN)

(21) Appl. No.: 18/996,412

(22) PCT Filed: Aug. 10, 2023
(86) PCT No.: PCT/US2023/029949

§ 371 Date: Jan. 17, 2025

Related U.S. Application Data
(60) Provisional application No. 63/397,770, filed on Aug. 12, 2022.

(51) Int. Cl. H04W 72/1268; H04L 5/00; H04W 72/231

(52) U.S. Cl. CPC H04W 72/1268; H04L 5/0044; H04W 72/231

(57) ABSTRACT

The disclosure relates to a method to be performed by a user equipment (UE). The method involves: generating one or IC more codewords for simultaneous uplink transmission via at least one antenna panel of the UE, wherein the one or more codewords are associated with a plurality of physical uplink shared channel (PUSCH) transmissions of a scheduled PUSCH transmission occasion; initializing, based on a number of the one or more codewords, a respective scrambling sequence generator for each of the one or more codewords; generating, using the respective scrambling sequence generator, a respective scrambling sequence for scrambling the one or more codewords; and scrambling the one or more codewords using the respective scrambling sequence.

### CROSS-REFERENCE TO RELATED APPLICATIONS

The present application claims priority to U.S. Prov. App. No. 63/397,770, filed on Aug. 12, 2022, entitled “SIMULTANEOUS TRANSMISSION ON MULTI-PANEL USER EQUIPMENT (UE),” which is incorporated herein by reference in its entirety.

### BACKGROUND

Wireless communication networks provide integrated communication platforms and telecommunication services to wireless user devices. Example telecommunication services include telephony, data (e.g., voice, audio, and/or video data), messaging, internet-access, and/or other services. The wireless communication networks have wireless access nodes that exchange wireless signals with the wireless user devices using wireless network protocols, such as protocols described in various telecommunication standards promulgated by the Third Generation Partnership Project (3GPP). Example wireless communication networks include time division multiple access (TDMA) networks, frequency-division multiple access (FDMA) networks, orthogonal frequency-division multiple access (OFDMA) networks, Long Term Evolution (LTE), and Fifth Generation New Radio (5G NR). The wireless communication networks facilitate mobile broadband service using technologies such as OFDM, multiple input multiple output (MIMO), advanced channel coding, massive MIMO, beamforming, and/or other features.

In some wireless communication networks, a base station can include or utilize one or more transmission/reception points (TRPs) to communicate with a user equipment (UE). A TRP may have an antenna panel that includes one or more antenna elements, and that is located at a specific geographic location to serve a specific area. In order to increase network coverage, reliability, and data rates, some wireless communication networks support multi-TRP (m-TRP) operation. In m-TRP operation, a base station uses more than one TRP to communicate with a UE. To facilitate m-TRP operation, the UE can be a multi-panel UE that includes multiple antenna panels, with each panel having one or more antenna elements.

### SUMMARY

This disclosure describes methods and systems for physical uplink shared channel (PUSCH) scrambling in simultaneous multi-panel operations. In some implementations, a UE is scheduled to transmit one or more codewords. In these implementations, the UE is configured to initialize a respective scrambling sequence generator for the one or more codewords based on a number of the codewords. The UE is then configured to generate, using the respective scrambling sequence generator, a respective scrambling sequence for scrambling coded bits of the one or more codewords. The UE is further configured to scramble, using the respective scrambling sequence, the coded bits of the one or more codewords.

In accordance with one aspect of the present disclosure, a method to be performed by a user equipment (UE) is disclosed. The method involves generating one or more codewords for simultaneous uplink transmission via at least one antenna panel of the UE, where the one or more codewords are associated with a plurality of physical uplink shared channel (PUSCH) transmissions of a scheduled PUSCH transmission occasion; initializing, based on a number of the one or more codewords, a respective scrambling sequence generator for each of the one or more codewords; generating, using the respective scrambling sequence generator, a respective scrambling sequence for scrambling the one or more codewords; and scrambling the one or more codewords using the respective scrambling sequence.

The previously-described implementation is applicable using a computer-implemented method; a non-transitory, computer-readable medium storing computer-readable instructions to perform the computer-implemented method; and a computer system including a computer memory interoperably coupled with a hardware processor configured to perform the computer-implemented method or the instructions stored on the non-transitory, computer-readable medium. These and other embodiments may each optionally include one or more of the following features.

In some implementations, the UE is served by a base station, and the method further involves simultaneously transmitting the plurality of PUSCH transmissions to the base station via the at least one antenna panel, wherein the plurality of PUSCH transmissions comprise the scrambled one or more codewords.

In some implementations, simultaneously transmitting the plurality of PUSCH transmissions to the base station via the at least one antenna panel involves: transmitting a first PUSCH transmission toward a first transmission/reception point (TRP) of the base station via a first antenna panel; and transmitting a second PUSCH transmission toward a second TRP of the base station via a second antenna panel.

In some implementations, initializing the respective scrambling sequence generator involves generating a respective initialization code based on the number of the one or more codewords.

In some implementations, the initialization code is: cᵢₙᵢₜ=n_{RNTI}·2¹⁵+q·2¹⁴+n_{ID}, where q is the number of the one or more codewords, where n_{RNTI} is a Radio Network Temporary Identifier (RNTI) of the transmission occasion, and where n_{ID} is a higher layer parameter.

In some implementations, generating the respective initialization code is further based on a parameter received from a base station via higher layer signaling.

In some implementations, the method further involves receiving a single Downlink Control Information (DCI) scheduling the plurality of the PUSCH transmissions, where the plurality of PUSCH transmissions overlap in at least one of time or frequency. As an example, the single DCI can schedule a first PUSCH transmission and a second PUSCH transmission. The first PUSCH transmission and the second PUSCH transmission can be repetitions of the same transport block. Alternatively, the first PUSCH transmission and the second PUSCH transmission can be different portions of the same transport block. Further, the first PUSCH transmission and the second PUSCH transmission can be FDM or SDM.

In some implementations, the method further involves receiving a plurality of Downlink Control Information (DCI) scheduling the plurality of PUSCH transmissions, wherein the plurality of PUSCH transmissions are scheduled to overlap in at least one of time or frequency. As an example, the multiple DCIs can schedule a first PUSCH transmission and a second PUSCH transmission. The first PUSCH transmission and the second PUSCH transmission can be repetitions of the same transport block. Alternatively, the first PUSCH transmission and the second PUSCH transmission can be different portions of the same transport block. Further, the first PUSCH transmission and the second PUSCH transmission can be FDM or SDM.

In some implementations, the plurality of PUSCH transmissions are repetitions of a same transport block.

In some implementations, the plurality of PUSCH transmissions include different portions of a same transport block.

The details of one or more implementations of the subject matter of this specification are set forth in the Detailed Description, the accompanying drawings, and the claims. Other features, aspects, and advantages of the subject matter will become apparent from the description, the claims, and the accompanying drawings.

### BRIEF DESCRIPTION OF THE FIGURES

FIG. 1A and FIG. 1B illustrate example scheduling schemes for simultaneous transmission on a multi-panel user equipment, according to some implementations.

FIG. 2 illustrates a wireless network, according to some implementations.

FIG. 3 illustrates a flowchart of an example method, according to some implementations.

FIG. 4 illustrates a user equipment, according to some implementations.

FIG. 5 illustrates an access node, according to some implementations.

Like reference numbers and designations in the various drawings indicate like elements.

### DETAILED DESCRIPTION

In line with the discussion above, there are two different modes for multi-transmission/reception point (m-TRP) operations: single downlink control information (DCI) mode and multi-DCI mode. In single DCI mode, a base station uses a single DCI to trigger a user equipment (UE) to transmit a plurality of physical uplink shared channel (PUSCH) transmissions toward multiple TRPs of the base station. In multi-DCI mode, a base station uses multiple DCI to trigger a UE to transmit a plurality of PUSCH transmissions toward multiple TRPs of the base station. In both modes, the transmissions can be arranged for transmission from multiple antenna panels if the UE is a multi-panel UE. In this arrangement, a transmission from a particular antenna panel can be directed toward a corresponding TRP. Additionally, the uplink transmissions may be repetitions of the same transport block (TB). The uplink transmissions may additionally and/or alternatively be physical uplink control channel (PUCCH) transmissions.

In single DCI mode, the PUSCH transmissions can be scheduled such that there is an overlap in time between the different transmissions. In order to facilitate these simultaneous PUSCH transmissions on a multi-panel UE (STxMP), the following scheduling schemes can be used: (i) a spatial division multiplexing (SDM) scheme, (ii) a type-A frequency division multiplexing (FDM-A) scheme, and (iii) a type-B FDM (FDM-B) scheme. In the SDM scheme, different layers or demodulation reference signal (DMRS) ports of a single PUSCH transmission (e.g., that includes one or more transport blocks/codewords) are separately precoded and simultaneously transmitted from different UE panels. The different transmissions may overlap in time and frequency, but are transmitted in different spatial directions from different panels.

In the FDM-A scheme, different portions of a single PUSCH transmission are transmitted from different UE panels on non-overlapping frequency domain resources (e.g., orthogonal resources) and on the same time domain resources. In the FDM-B scheme, a plurality of repetitions of the same PUSCH transmission are transmitted from different UE panels on non-overlapping frequency domain resources and on the same time domain resources. In this scheme, the plurality of repetitions can be the same or different redundancy version (RV) of the same transport block.

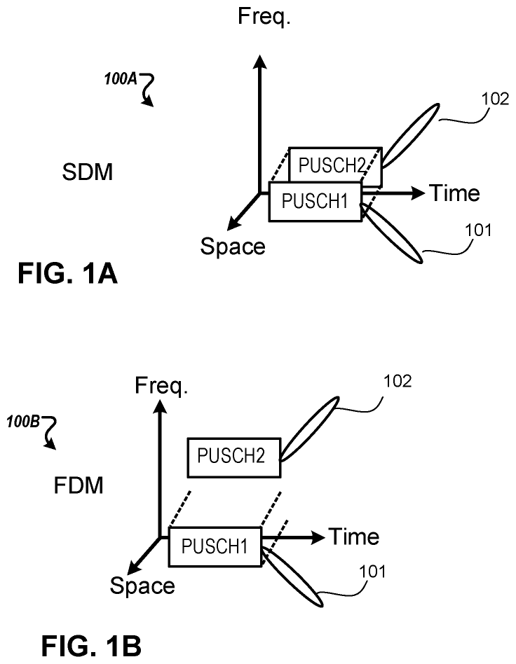

FIG. 1A and FIG. 1B illustrate example scheduling schemes 100A, 100B for simultaneous transmission on a multi-panel UE, according to some implementations. In these examples, a multi-panel UE (not illustrated) is scheduled to simultaneously transmit two PUSCH transmissions from respective panels toward multiple TRPs of a base station (not illustrated). The two PUSCH transmissions are labeled in the figures as PUSCH1 and PUSCH2. And the transmission from each panel is directed toward a corresponding TRP.

Turning to FIG. 1A, the PUSCH transmission includes PUSCH1 and PUSCH2, which are scheduled to occur during the same time period. Under the SDM scheme 100A, PUSCH1 and PUSCH2 fully overlap in time and frequency, but are spatially divided on two panels 101 and 102. Each panel transmits a beam that carries the transmission toward a corresponding TRP. Under this scheme, PUSCH1 and PUSCH2 each include different layers of a single PUSCH transmission, which, in turn, includes one or more transport blocks/codewords.

In FIG. 1B, the PUSCH transmission includes PUSCH1 and PUSCH2, which are scheduled to occur during the same time period. Under the FDM scheme 100B, PUSCH1 and PUSCH2 do not overlap in frequency but are multiplexed on different frequency bands. PUSCH1 and PUSCH2 are then transmitted by the two panels 101 and 102 toward corresponding TRPs. If the scheme is FDM-A, then PUSCH1 and PUSCH2 are different portions of the same PUSCH transmission. That is, PUSCH1 and PUSCH2 together form the entire PUSCH transmission. If the scheme is FDM-B, then repetitions of the same PUSCH transmission are transmitted in PUSCH1 and PUSCH2. That is, each of PUSCH1 and PUSCH2 includes a repetition of the same information. Note that, in some scenarios, PUSCH1 and PUSCH2 can be frequency division multiplexed such that they are partially overlapping in frequency.

However, currently some issues related to the described PUSCH constructions for STxMP have not yet been addressed by the Third Generation Partnership Project (3GPP) technical specifications. One of these issues is related to PUSCH scrambling. In the existing 3GPP technical specifications, the scrambling procedure assumes that only a single codeword is transmitted in single DCI mode. Additionally, the scrambling procedure assumes that only non-overlapping PUSCH transmissions are transmitted in multi-DCI mode. A UE operating according to these assumptions is not capable of properly utilizing STxMP operations since the assumptions do not account for STxMP features (e.g., transmitting multiple codewords in single DCI mode and transmitting overlapping PUSCH transmissions in single DCI mode or multi-DCI mode). More specifically, the existing technical specifications do not have mechanisms for scrambling multiple codewords for simultaneous transmission.

This disclosure describes methods and systems for PUSCH scrambling in STxMP operations. As described in more detail below, unlike existing scrambling techniques, the disclosed scrambling sequences are generated based on a number of codewords to be transmitted. In some implementations, a UE is scheduled to transmit one or more codewords. In these implementations, the UE is configured to initialize a respective scrambling sequence generator for the one or more codewords based on a number of the codewords. The UE is then configured to generate, using the respective scrambling sequence generator, a respective scrambling sequence for scrambling coded bits of the one or more codewords. The UE is further configured to scramble, using the respective scrambling sequence, the coded bits of the one or more codewords.

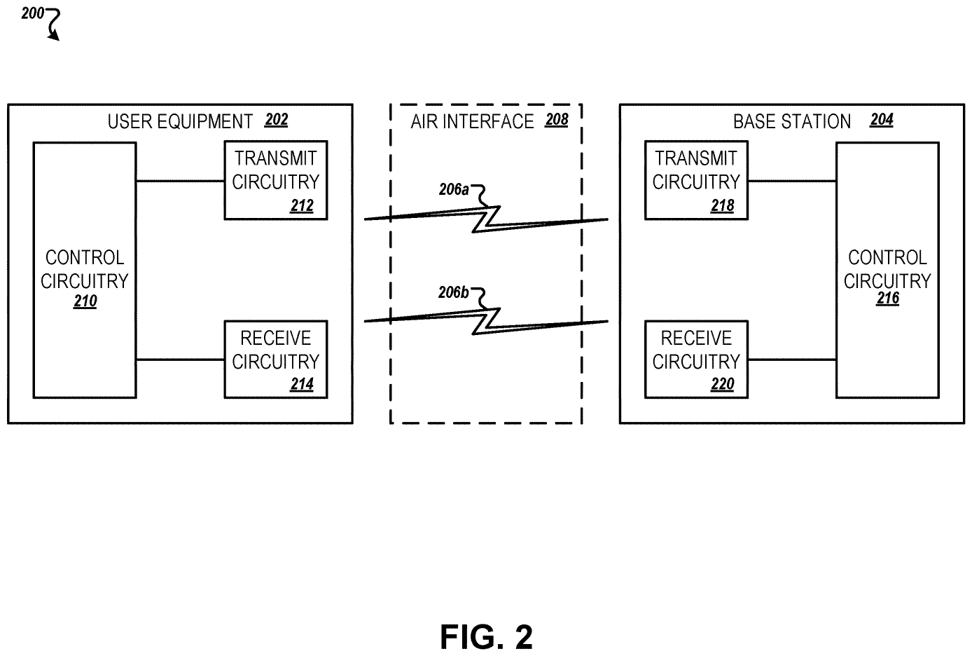

FIG. 2 illustrates a wireless network 200, according to some implementations. The wireless network 200 includes a UE 202 and a base station 204 connected via one or more channels 206A, 206B across an air interface 208. The UE 202 and base station 204 communicate using a system that supports controls for managing the access of the UE 202 to a network via the base station 204.

In some implementations, the wireless network 200 may be a Standalone (SA) network that incorporates Fifth Generation (5G) New Radio (NR) communication standards as defined by 3GPP technical specifications. In other implementations, the wireless network 200 may be a Non-Standalone (NSA) network that incorporates Long Term Evolution (LTE) and 5G NR communication standards. For example, the wireless network 200 may be a E-UTRA (Evolved Universal Terrestrial Radio Access)-NR Dual Connectivity (EN-DC) network, or a NR-EUTRA Dual Connectivity (NE-DC) network. Furthermore, other types of communication standards are possible, including future 3GPP systems (e.g., Sixth Generation [6G]) systems, Institute of Electrical and Electronics Engineers (IEEE) 802.11 technology, or the like. While aspects may be described herein using terminology commonly associated with 5G NR, aspects of the present disclosure can be applied to other systems, such as 3G, 4G, and/or systems subsequent to 5G (e.g., 6G).

In the wireless network 200, the UE 202 and any other UE in the system may be, for example, laptop computers, smartphones, tablet computers, machine-type devices such as smart meters, intelligent transportation systems, or any other wireless devices with or without a user interface. In network 200, the base station 204 provides the UE 202 network connectivity to a broader network (not shown). This UE 202 connectivity is provided via the air interface 208 in a base station service area provided by the base station 204. In some implementations, such a broader network may be a wide area network operated by a cellular network provider, or may be the Internet. Each base station service area associated with the base station 204 is supported by antennas integrated with the base station 204. The service areas are divided into a number of sectors associated with certain antennas. Such sectors may be physically associated with fixed antennas or may be assigned to a physical area with tunable antennas or antenna settings adjustable in a beamforming process used to direct a signal to a particular sector.

The UE 202 includes control circuitry 210 coupled with transmit circuitry 212 and receive circuitry 214. The transmit circuitry 212 and receive circuitry 214 may each be coupled with one or more antennas. The control circuitry 210 may include various combinations of application-specific circuitry and baseband circuitry. The transmit circuitry 212 and receive circuitry 214 may be adapted to transmit and receive data, respectively, and may include radio frequency (RF) circuitry or front-end module (FEM) circuitry.

In various implementations, aspects of the transmit circuitry 212, receive circuitry 214, and control circuitry 210 may be integrated in various ways to implement the operations described herein. The control circuitry 210 may be adapted or configured to perform various operations such as those described elsewhere in this disclosure related to a UE.

Additionally, the transmit circuitry 212 may transmit a plurality of multiplexed uplink physical channels. The plurality of uplink physical channels may be multiplexed according to time division multiplexing (TDM) or frequency division multiplexing (FDM) along with carrier aggregation. The transmit circuitry 212 may be configured to receive block data from the control circuitry 210 for transmission across the air interface 208.

Additionally, the receive circuitry 214 may receive a plurality of multiplexed downlink physical channels from the air interface 208 and relay the physical channels to the control circuitry 210. The plurality of downlink physical channels may be multiplexed according to TDM or FDM along with carrier aggregation. The transmit circuitry 212 and the receive circuitry 214 may transmit and receive both control data and content data (e.g., messages, images, video, etc.) structured within data blocks that are carried by the physical channels.

FIG. 2 also illustrates the base station 204. In implementations, the base station 204 may be an NG radio access network (RAN) or a 5G RAN, an E-UTRAN, a non-terrestrial cell, or a legacy RAN, such as a UTRAN. As used herein, the term “NG RAN” or the like may refer to the base station 204 that operates in an NR or 5G wireless network 200, and the term “E-UTRAN” or the like may refer to a base station 204 that operates in an LTE or 4G wireless network 200. The UE 202 utilizes connections (or channels) 206A, 206B, each of which includes a physical communications interface or layer.

The base station 204 circuitry may include control circuitry 216 coupled with transmit circuitry 218 and receive circuitry 220. The transmit circuitry 218 and receive circuitry 220 may each be coupled with one or more antennas that may be used to enable communications via the air interface 208. The transmit circuitry 218 and receive circuitry 220 may be adapted to transmit and receive data, respectively, to any UE connected to the base station 204. The transmit circuitry 218 may transmit downlink physical channels includes of a plurality of downlink subframes. The receive circuitry 220 may receive a plurality of uplink physical channels from various UEs, including the UE 202.

In FIG. 2, the one or more channels 206A, 206B are illustrated as an air interface to enable communicative coupling, and can be consistent with cellular communications protocols, such as a 3GPP LTE protocol, an Advanced long term evolution (LTE-A) protocol, a LTE-based access to unlicensed spectrum (LTE-U), a 5G protocol, a NR protocol, an NR-based access to unlicensed spectrum (NR-U) protocol, and/or any of the other communications protocols discussed herein. In implementations, the UE 202 may directly exchange communication data with another UE (not depicted) via a ProSe interface. The ProSe interface may alternatively be referred to as a sidelink (SL) interface and may include one or more logical channels, including but not limited to a Physical Sidelink Control Channel (PSCCH), a Physical Sidelink Shared Channel (PSSCH), a Physical Sidelink Discovery Channel (PSDCH), and a Physical Sidelink Broadcast Channel (PSBCH).

In some implementations, the UE 202 is configured to perform simultaneous multi-panel UL transmissions, e.g., PUSCH transmissions. The multi-panel UL transmissions may be part of a transmission occasion that is scheduled by a single DCI or multiple DCI. In simultaneous multi-panel transmissions, the transmission from each panel may be directed toward a corresponding TRP of the base station 204. The UE 202 can transmit one or more layers across the antenna panels, and can transmit one or more codewords across the antenna panels. In one example, the number of layers is up to four across all antenna panels, and the number of codewords is up to two across all antenna panels. Other numbers of layers and codewords are also possible.

In some implementations, the received DCI schedules an UL transmission occasion for transmitting one or more codewords. The UL transmission occasion can include resource elements (e.g., time and frequency resources) allocated to the UE 202 for the UL transmission. In response to receiving the DCI, the UE 202 is configured to prepare the one or more codewords for transmission in the UL transmission opportunity. As an example, the UE 202 can use SDM, FDM-A, or FDM-B to perform the transmission as simultaneous multi-panel transmissions.

In some implementations, as part of the procedure for generating a PUSCH transmission of a codeword, the UE 202 is configured to scramble coded bits of the codeword before modulation. For example, the UE 202 can use a scrambling sequence to scramble the coded bits of the codeword. According to existing technical specifications, the scrambling sequence, c^{q}(i), is generated based on a pseudo random sequence generation algorithm, e.g., as described in TS 38.211 Sections 5.2.1, 6.3.1.1. TS 38.211 Section 6.3.1.1 states: For the single codeword q=0, the block of bits

$${b}^{( q )} ( 0 ) , … , {b}^{( q )} ( {M}_{b i t}^{( q )} - 1 ) ,$$

where

$${M}_{b i t}^{( q )}$$

is the number of bits in codeword q transmitted on the physical channel, shall be scrambled prior to modulation, resulting in a block of scrambled bits

$${\tilde{b}}^{( q )} ( 0 ) , … , {\tilde{b}}^{( q )} ( {M}_{b i t}^{( q )} - 1 )$$

according to the following pseudo code

```
Set i = 0
$while i < {M}_{bit}^{( q )}$
  if b^{(q)} (i) = x  // UCI placeholder bits
    \tilde{b}^{(q)} (i) = 1
  else
    if b^{(q)} (i) = y // UCI placeholder bits
      \tilde{b}^{(q)} (i) = \tilde{b}^{(q)} (i − 1)
    else
      \tilde{b}^{(q)} (i) = (b^{(q)} (i) + c^{(q)} (i))mod 2
    end if
  end if
  i = i + 1
end while
where x and y are tags defined in [TS 38.212] and where the scrambling sequence c^{(q)} (i) is
given by clause 5.2.1.
The scrambling sequence generator shall be initialized with
    ${c}_{init} = \{ \begin{matrix}{n}_{RNTI} \cdot {2}^{16} + {n}_{RAPID} \cdot {2}^{10} + {n}_{ID} & for msgA on PUSCH \\ {n}_{RNTI} \cdot {2}^{15} + {n}_{ID} & otherwise\end{matrix}$
where
  n_{ID} ∈ {0, 1, . . . , 1023} equals the higher-layer parameter dataScramblingIdentityPUSCH if
  configured and the RNTI equals the C-RNTI, MCS-C-RNTI, SP-CSI-RNTI or CS-
  RNTI, and the transmission is not scheduled using DCI format 0_0 in a common search space;
  n_{ID} ∈ {0, 1, . . . , 1023} equals the higher-layer parameter msgA-DataScramblingIndex if
  configured and the PUSCH transmission is triggered by a Type-2 random access
  procedure as described in clause 8.1A of [TS 38.213];
  ${n}_{ID} = {N}_{ID}^{cell} otherwise$
  N_{RAPID} is the index of the random-access preamble transmitted for msgA as described
  in clause 5.1.3A of TS 38.321
and where n_{RNTI} equals the RA-RNTI for msgA and otherwise corresponds to the RNTI
associated with the PUSCH transmission as described in clause 6.1 of TS 38.214 and clause
8.3 of TS 38.213.
```

As shown in Section 6.3.1.1, the scrambling sequence c^{(q)}(i) in the existing specifications is independent of the codeword q, as only one codeword is supported for PUSCH (i.e., q=0). As also shown by Section 6.3.1.1, the scrambling sequence generator for PUSCH is initialized independent of the codeword q.

In some implementations, instead of the using the existing initialization code described above, the UE 202 is configured to generate an initialization code based on the number of codewords that the UE 202 is scheduled to transmit in the simultaneous multi-panel transmission. In some implementations, the initialization code is defined by Equation [1] as:

$${c}_{init} = \{ \begin{matrix}{n}_{RNTI} \cdot {2}^{16} + {n}_{RAPID} \cdot {2}^{10} + {n}_{ID} & for msgA on PUSCH \\ {n}_{RNTI} \cdot {2}^{15} + q \cdot {2}^{14} {n}_{ID} & otherwise\end{matrix} , \qquad [ 1 ]$$

In Equation [1], q is the number of codewords to be transmitted, n_{RNTI} is the Radio Network Temporary Identifier (RNTI) associated with the PUSCH transmission, and n_{ID} is based on a higher layer parameter.

In one example, n_{ID}∈{0, 1, . . . , 1023} equals:
a higher-layer parameter dataScramblingIdentityPUSCH if the one or more codewords are scheduled using a Control Resource Set (CORESET) with CORESETPoolIndex equal to 0; or
a higher-layer parameter dataScramblingIdentityPUSCH2 if the one or more codewords are scheduled using the CORESET with the CORESETPoolIndex equal to 1.
   In this example, the UE 202 uses the second identity, dataScramblingIdentityPUSCH2, if the UE 202 is scheduled to simultaneously transmit multiple PUSCH transmissions.

In some implementations, the UE 202 is configured to generate a respective initialization code for each codeword that is being transmitted. The UE 202 then uses the respective initialization code to generate a respective scrambling code for the one or more codewords. In examples where the UE 202 is transmitting repetitions of the same codeword, the repetitions of each codeword have the same scrambling sequence (although they may have different RV indices).

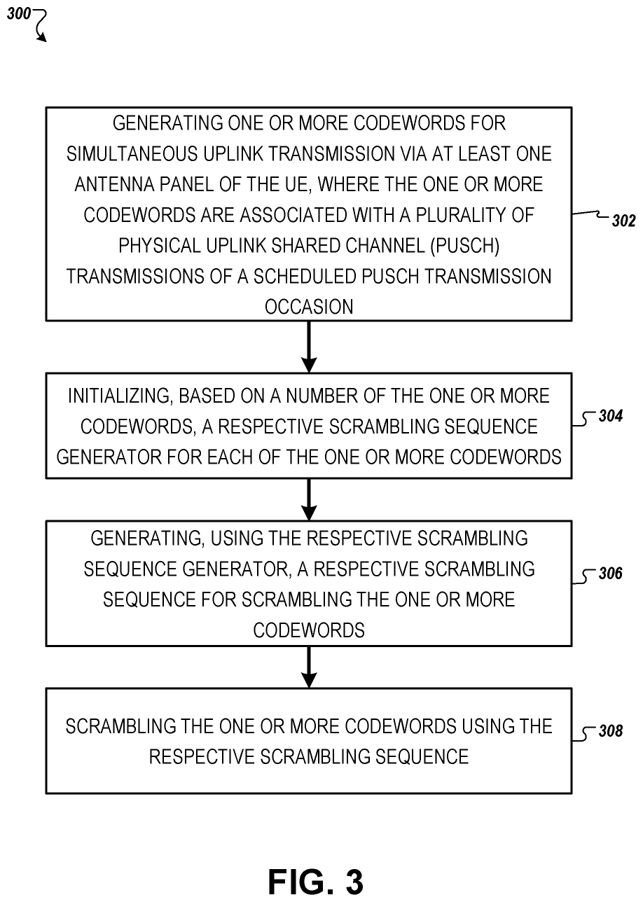

FIG. 3 illustrates a flowchart of an example method 300, according to some implementations. For clarity of presentation, the description that follows generally describes method 300 in the context of the other figures in this description. For example, method 300 can be performed by UE 202 of FIG. 2. It will be understood that method 300 can be performed, for example, by any suitable system, environment, software, hardware, or a combination of systems, environments, software, and hardware, as appropriate. In some implementations, various steps of method 300 can be run in parallel, in combination, in loops, or in any order.

At 302, method 300 involves generating one or more codewords for simultaneous uplink transmission via at least one antenna panel of the UE, where the one or more codewords are associated with a plurality of physical uplink shared channel (PUSCH) transmissions of a scheduled PUSCH transmission occasion.

At 304, method 300 involves initializing, based on a number of the one or more codewords, a respective scrambling sequence generator for each of the one or more codewords.

At 306, method 300 involves generating, using the respective scrambling sequence generator, a respective scrambling sequence for scrambling the one or more codewords.

At 308, method 300 involves scrambling the one or more codewords using the respective scrambling sequence.

In some implementations, the UE is served by a base station, and the method further involves simultaneously transmitting the plurality of PUSCH transmissions to the base station via the at least one antenna panel, wherein the plurality of PUSCH transmissions comprise the scrambled one or more codewords.

In some implementations, simultaneously transmitting the plurality of PUSCH transmissions to the base station via the at least one antenna panel involves: transmitting a first PUSCH transmission toward a first transmission/reception point (TRP) of the base station via a first antenna panel; and transmitting a second PUSCH transmission toward a second TRP of the base station via a second antenna panel.

In some implementations, initializing the respective scrambling sequence generator involves generating a respective initialization code based on the number of the one or more codewords.

In some implementations, the initialization code is: cᵢₙᵢₜ=n_{RNTI}·2¹⁵+q·2¹⁴+n_{ID}, where q is the number of the one or more codewords, where n_{RNTI} is a Radio Network Temporary Identifier (RNTI) of the transmission occasion, and where n_{ID} is a higher layer parameter.

In some implementations, generating the respective initialization code is further based on a parameter received from a base station via higher layer signaling.

In some implementations, the method further involves receiving a single Downlink Control Information (DCI) scheduling the plurality of the PUSCH transmissions, where the plurality of PUSCH transmissions overlap in at least one of time or frequency. As an example, the single DCI can schedule a first PUSCH transmission and a second PUSCH transmission. The first PUSCH transmission and the second PUSCH transmission can be repetitions of the same transport block. Alternatively, the first PUSCH transmission and the second PUSCH transmission can be different portions of the same transport block. Further, the first PUSCH transmission and the second PUSCH transmission can be FDM or SDM.

In some implementations, the method further involves receiving a plurality of Downlink Control Information (DCI) scheduling the plurality of PUSCH transmissions, wherein the plurality of PUSCH transmissions are scheduled to overlap in at least one of time or frequency. As an example, the multiple DCIs can schedule a first PUSCH transmission and a second PUSCH transmission. The first PUSCH transmission and the second PUSCH transmission can be repetitions of the same transport block. Alternatively, the first PUSCH transmission and the second PUSCH transmission can be different portions of the same transport block. Further, the first PUSCH transmission and the second PUSCH transmission can be FDM or SDM.

In some implementations, the plurality of PUSCH transmissions are repetitions of a same transport block.

In some implementations, the plurality of PUSCH transmissions include different portions of a same transport block.

In some implementations, the one or more codewords are two codewords and the at least one antenna panel is one antenna panel. In these implementations, each codeword can include a plurality of layers, and each codeword has its own modulation and coding scheme (MCS).

The example method 300 shown in FIG. 3 can be modified or reconfigured to include additional, fewer, or different steps (not shown in FIG. 3), which can be performed in the order shown or in a different order.

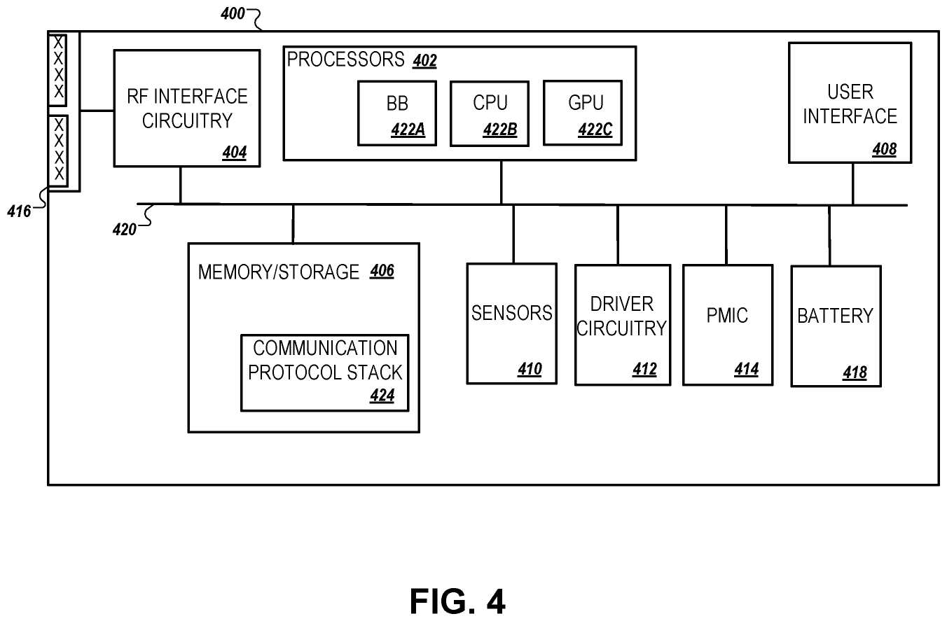

FIG. 4 illustrates a UE 400, according to some implementations. The UE 400 may be similar to and substantially interchangeable with UE 202 of FIG. 2.

The UE 400 may be any mobile or non-mobile computing device, such as, for example, mobile phones, computers, tablets, industrial wireless sensors (for example, microphones, pressure sensors, thermometers, motion sensors, accelerometers, inventory sensors, electric voltage/current meters, etc.), video devices (for example, cameras, video cameras, etc.), wearable devices (for example, a smart watch), relaxed-IoT devices.

The UE 400 may include processors 402, RF interface circuitry 404, memory/storage 406, user interface 408, sensors 410, driver circuitry 412, power management integrated circuit (PMIC) 414, one or more antennas 416, and battery 418. The components of the UE 400 may be implemented as integrated circuits (ICs), portions thereof, discrete electronic devices, or other modules, logic, hardware, software, firmware, or a combination thereof. The block diagram of FIG. 4 is intended to show a high-level view of some of the components of the UE 400. However, some of the components shown may be omitted, additional components may be present, and different arrangement of the components shown may occur in other implementations.

The components of the UE 400 may be coupled with various other components over one or more interconnects 420, which may represent any type of interface, input/output, bus (local, system, or expansion), transmission line, trace, optical connection, etc. that allows various circuit components (on common or different chips or chipsets) to interact with one another.

The processors 402 may include processor circuitry such as, for example, baseband processor circuitry (BB) 422A, central processor unit circuitry (CPU) 422B, and graphics processor unit circuitry (GPU) 422C. The processors 402 may include any type of circuitry or processor circuitry that executes or otherwise operates computer-executable instructions, such as program code, software modules, or functional processes from memory/storage 406 to cause the UE 400 to perform operations as described herein.

In some implementations, the processors 402 are configured to cause the UE to generate one or more codewords for simultaneous uplink transmission via at least one antenna panel of the UE, where the one or more codewords are associated with a plurality of physical uplink shared channel (PUSCH) transmissions of a scheduled PUSCH transmission occasion. Additionally, the processors 402 are configured to cause the UE to initialize, based on a number of the one or more codewords, a respective scrambling sequence generator for each of the one or more codewords. Further, the processors 402 are configured to cause the UE to generate, using the respective scrambling sequence generator, a respective scrambling sequence for scrambling the one or more codewords. Yet further, the processors 402 are configured to cause the UE to scramble the one or more codewords using the respective scrambling sequence.

In some implementations, the baseband processor circuitry 422A may access a communication protocol stack 424 in the memory/storage 406 to communicate over a 3GPP compatible network. In general, the baseband processor circuitry 422A may access the communication protocol stack to: perform user plane functions at a physical (PHY) layer, medium access control (MAC) layer, radio link control (RLC) layer, packet data convergence protocol (PDCP) layer, service data adaptation protocol (SDAP) layer, and PDU layer; and perform control plane functions at a PHY layer, MAC layer, RLC layer, PDCP layer, RRC layer, and a non-access stratum layer. In some implementations, the PHY layer operations may additionally/alternatively be performed by the components of the RF interface circuitry 404. The baseband processor circuitry 422A may generate or process baseband signals or waveforms that carry information in 3GPP-compatible networks. In some implementations, the waveforms for NR may be based cyclic prefix orthogonal frequency division multiplexing (OFDM) “CP-OFDM” in the uplink or downlink, and discrete Fourier transform spread OFDM “DFT-S-OFDM” in the uplink.

The memory/storage 406 may include one or more non-transitory, computer-readable media that includes instructions (for example, communication protocol stack 424) that may be executed by one or more of the processors 402 to cause the UE 400 to perform various operations described herein. The memory/storage 406 include any type of volatile or non-volatile memory that may be distributed throughout the UE 400. In some implementations, some of the memory/storage 406 may be located on the processors 402 themselves (for example, L1 and L2 cache), while other memory/storage 406 is external to the processors 402 but accessible thereto via a memory interface. The memory/storage 406 may include any suitable volatile or non-volatile memory such as, but not limited to, dynamic random access memory (DRAM), static random access memory (SRAM), erasable programmable read only memory (EPROM), electrically erasable programmable read only memory (EEPROM), Flash memory, solid-state memory, or any other type of memory device technology.

The RF interface circuitry 404 may include transceiver circuitry and radio frequency front module (RFEM) that allows the UE 400 to communicate with other devices over a radio access network. The RF interface circuitry 404 may include various elements arranged in transmit or receive paths. These elements may include, for example, switches, mixers, amplifiers, filters, synthesizer circuitry, control circuitry, etc.

In the receive path, the RFEM may receive a radiated signal from an air interface via one or more antennas 416 and proceed to filter and amplify (with a low-noise amplifier) the signal. The signal may be provided to a receiver of the transceiver that downconverts the RF signal into a baseband signal that is provided to the baseband processor of the processors 402.

In the transmit path, the transmitter of the transceiver up-converts the baseband signal received from the baseband processor and provides the RF signal to the RFEM. The RFEM may amplify the RF signal through a power amplifier prior to the signal being radiated across the air interface via the antenna 416. In various implementations, the RF interface circuitry 404 may be configured to transmit/receive signals in a manner compatible with NR access technologies.

The antenna 416 may include antenna elements to convert electrical signals into radio waves to travel through the air and to convert received radio waves into electrical signals. The antenna elements may be arranged into one or more antenna panels. The antenna 416 may have antenna panels that are omnidirectional, directional, or a combination thereof to enable beamforming and multiple input, multiple output communications. The antenna 416 may include microstrip antennas, printed antennas fabricated on the surface of one or more printed circuit boards, patch antennas, phased array antennas, etc. The antenna 416 may have one or more panels designed for specific frequency bands including bands in FR1 or FR2.

The user interface 408 includes various input/output (I/O) devices designed to enable user interaction with the UE 400. The user interface 408 includes input device circuitry and output device circuitry. Input device circuitry includes any physical or virtual means for accepting an input including, inter alia, one or more physical or virtual buttons (for example, a reset button), a physical keyboard, keypad, mouse, touchpad, touchscreen, microphones, scanner, headset, or the like. The output device circuitry includes any physical or virtual means for showing information or otherwise conveying information, such as sensor readings, actuator position(s), or other like information. Output device circuitry may include any number or combinations of audio or visual display, including, inter alia, one or more simple visual outputs/indicators (for example, binary status indicators such as light emitting diodes “LEDs” and multi-character visual outputs), or more complex outputs such as display devices or touchscreens (for example, liquid crystal displays “LCDs,” LED displays, quantum dot displays, projectors, etc.), with the output of characters, graphics, multimedia objects, and the like being generated or produced from the operation of the UE 400.

The sensors 410 may include devices, modules, or subsystems whose purpose is to detect events or changes in its environment and send the information (sensor data) about the detected events to some other device, module, subsystem, etc. Examples of such sensors include, inter alia, inertia measurement units including accelerometers, gyroscopes, or magnetometers; microelectromechanical systems or nanoelectromechanical systems including 3-axis accelerometers, 3-axis gyroscopes, or magnetometers; level sensors; temperature sensors (for example, thermistors); pressure sensors; image capture devices (for example, cameras or lensless apertures); light detection and ranging sensors; proximity sensors (for example, infrared radiation detector and the like); depth sensors; ambient light sensors; ultrasonic transceivers; microphones or other like audio capture devices; etc.

The driver circuitry 412 may include software and hardware elements that operate to control particular devices that are embedded in the UE 400, attached to the UE 400, or otherwise communicatively coupled with the UE 400. The driver circuitry 412 may include individual drivers allowing other components to interact with or control various input/output (I/O) devices that may be present within, or connected to, the UE 400. For example, driver circuitry 412 may include a display driver to control and allow access to a display device, a touchscreen driver to control and allow access to a touchscreen interface, sensor drivers to obtain sensor readings of sensors 410 and control and allow access to sensors 410, drivers to obtain actuator positions of electro-mechanic components or control and allow access to the electro-mechanic components, a camera driver to control and allow access to an embedded image capture device, audio drivers to control and allow access to one or more audio devices.

The PMIC 414 may manage power provided to various components of the UE 400. In particular, with respect to the processors 402, the PMIC 414 may control power-source selection, voltage scaling, battery charging, or DC-to-DC conversion.

In some implementations, the PMIC 414 may control, or otherwise be part of, various power saving mechanisms of the UE 400. A battery 418 may power the UE 400, although in some examples the UE 400 may be mounted deployed in a fixed location, and may have a power supply coupled to an electrical grid. The battery 418 may be a lithium ion battery, a metal-air battery, such as a zinc-air battery, an aluminum-air battery, a lithium-air battery, and the like. In some implementations, such as in vehicle-based applications, the battery 418 may be a typical lead-acid automotive battery.

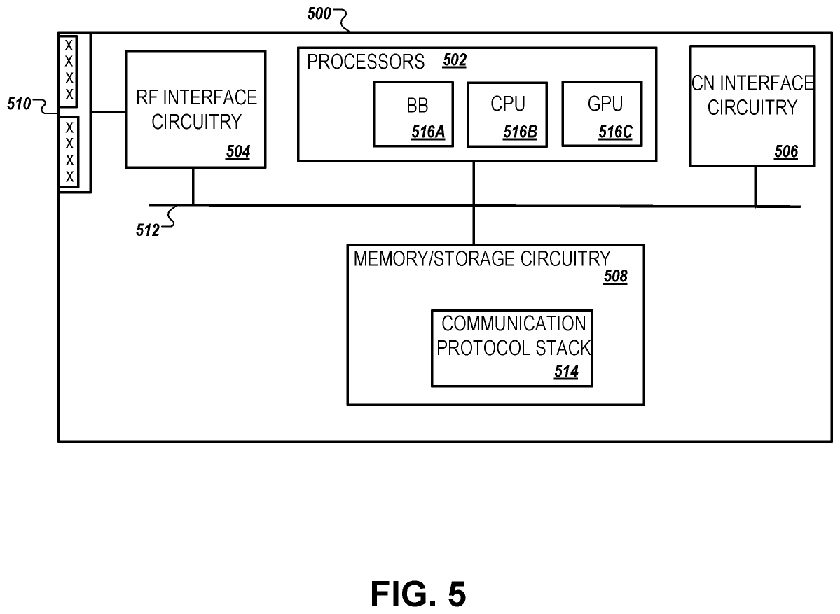

FIG. 5 illustrates an access node 500 (e.g., a base station, TRP, or gNB), according to some implementations. The access node 500 may be similar to and substantially interchangeable with base station 204. The access node 500 may include processors 502, RF interface circuitry 504, core network (CN) interface circuitry 506, memory/storage circuitry 508, and one or more antennas 510.

The components of the access node 500 may be coupled with various other components over one or more interconnects 512. The processors 502, RF interface circuitry 504, memory/storage circuitry 508 (including communication protocol stack 514), one or more antennas 510, and interconnects 512 may be similar to like-named elements shown and described with respect to FIG. 4. For example, the processors 502 may include processor circuitry such as, for example, baseband processor circuitry (BB) 516A, central processor unit circuitry (CPU) 516B, and graphics processor unit circuitry (GPU) 516C.

The CN interface circuitry 506 may provide connectivity to a core network, for example, a 5th Generation Core network (5GC) using a 5GC-compatible network interface protocol such as carrier Ethernet protocols, or some other suitable protocol. Network connectivity may be provided to/from the access node 500 via a fiber optic or wireless backhaul. The CN interface circuitry 506 may include one or more dedicated processors or FPGAs to communicate using one or more of the aforementioned protocols. In some implementations, the CN interface circuitry 506 may include multiple controllers to provide connectivity to other networks using the same or different protocols.

As used herein, the terms “access node,” “access point,” or the like may describe equipment that provides the radio baseband functions for data and/or voice connectivity between a network and one or more users. These access nodes can be referred to as BS, gNBs, RAN nodes, eNBs, NodeBs, RSUs, TRxPs or TRPs, and so forth, and can include ground stations (e.g., terrestrial access points) or satellite stations providing coverage within a geographic area (e.g., a cell). As used herein, the term “NG RAN node” or the like may refer to an access node 500 that operates in an NR or 5G system (for example, a gNB), and the term “E-UTRAN node” or the like may refer to an access node 500 that operates in an LTE or 4G system (e.g., an eNB). According to various implementations, the access node 500 may be implemented as one or more of a dedicated physical device such as a macrocell base station, and/or a low power (LP) base station for providing femtocells, picocells or other like cells having smaller coverage areas, smaller user capacity, or higher bandwidth compared to macrocells.

In some implementations, all or parts of the access node 500 may be implemented as one or more software entities running on server computers as part of a virtual network, which may be referred to as a CRAN and/or a virtual baseband unit pool (vBBUP). In V2X scenarios, the access node 500 may be or act as a “Road Side Unit.” The term “Road Side Unit” or “RSU” may refer to any transportation infrastructure entity used for V2X communications. An RSU may be implemented in or by a suitable RAN node or a stationary (or relatively stationary) UE, where an RSU implemented in or by a UE may be referred to as a “UE-type RSU,” an RSU implemented in or by an eNB may be referred to as an “eNB-type RSU,” an RSU implemented in or by a gNB may be referred to as a “gNB-type RSU,” and the like.

In some implementations, as a TRP, the access node 500 is configured to transmit a single DCI (in single DCI mode) or multiple DCI (in multiple DCI mode) to a UE. Additionally, the access node 500 is configured to receive one or more of the simultaneous multi-panel transmissions performed by a UE that is served by the access node 500. As described, the simultaneous multi-panel transmissions include one or more scrambled codewords. Further, the access node 500 is configured to signal to the UE via higher layer signaling (e.g., RRC signaling) a higher layer parameter that the UE can use to determine n_{ID}.

Various components may be described as performing a task or tasks, for convenience in the description. Such descriptions should be interpreted as including the phrase “configured to.” Reciting a component that is configured to perform one or more tasks is expressly intended not to invoke 35 U.S.C. § 112(f) interpretation for that component.

For one or more embodiments, at least one of the components set forth in one or more of the preceding figures may be configured to perform one or more operations, techniques, processes, or methods as set forth in the example section below. For example, the baseband circuitry as described above in connection with one or more of the preceding figures may be configured to operate in accordance with one or more of the examples set forth below. For another example, circuitry associated with a UE, base station, network element, etc. as described above in connection with one or more of the preceding figures may be configured to operate in accordance with one or more of the examples set forth below in the example section.

### Examples

Example 1 includes one or more processors of a user equipment (UE), the one or more processors configured to cause the UE to perform operations including: generating one or more codewords for simultaneous uplink transmission via at least one antenna panel of the UE, where the one or more codewords are associated with a plurality of physical uplink shared channel (PUSCH) transmissions of a scheduled PUSCH transmission occasion; initializing, based on a number of the one or more codewords, a respective scrambling sequence generator for each of the one or more codewords; generating, using the respective scrambling sequence generator, a respective scrambling sequence for scrambling the one or more codewords; and scrambling the one or more codewords using the respective scrambling sequence.

Example 2 is the one or more processors of Example 1, where the UE is served by a base station, and where the operations further include: simultaneously transmitting the plurality of PUSCH transmissions to the base station via the at least one antenna panel, where the plurality of PUSCH transmissions comprise the scrambled one or more codewords.

Example 3 is the one or more processors of Example 2, where simultaneously transmitting the plurality of PUSCH transmissions to the base station via the at least one antenna panel includes: transmitting a first PUSCH transmission toward a first transmission/reception point (TRP) of the base station via a first antenna panel; and transmitting a second PUSCH transmission toward a second TRP of the base station via a second antenna panel.

Example 4 is the one or more processors of any of Examples 1-3, where initializing the respective scrambling sequence generator comprises generating a respective initialization code based on the number of the one or more codewords.

Example 5 is the one or more processors of Example 4, where the initialization code includes:

$${c}_{i m t} = {n}_{RNTI} \cdot {2}^{15} + q \cdot {2}^{14} + {n}_{ID} ,$$

where q is the number of the one or more codewords, where n_{RNTI} is a Radio Network Temporary Identifier (RNTI) associated with the PUSCH transmission occasion, and where n_{ID} is a higher layer parameter.

Example 6 is the one or more processors of Example 4, where generating the respective initialization code is further based on a parameter received from a base station via higher layer signaling.

Example 7 is the one or more processors of any of Examples 1-6, the operations further including: receiving a single Downlink Control Information (DCI) scheduling the plurality of the PUSCH transmissions, where the plurality of PUSCH transmissions overlap in at least one of time or frequency.

Example 8 is the one or more processors of any of Examples 1-6, the operations further including: receiving a plurality of Downlink Control Information (DCI) scheduling the plurality of PUSCH transmissions, where the plurality of PUSCH transmissions are scheduled to overlap in at least one of time or frequency.

Example 9 is the one or more processors of any of examples 1-8, where the plurality of PUSCH transmissions are repetitions of a same transport block.

Example 10 is the one or more processors of any of examples 1-8, where the plurality of PUSCH transmissions include different portions of a same transport block.

Example 11 may include a non-transitory computer storage medium encoded with instructions that, when executed by one or more computers, cause the one or more computers to perform the operations of any of Examples 1 to 10.

Example 12 may include a system including one or more computers and one or more storage devices on which are stored instructions that are operable, when executed by the one or more computers, to cause the one or more computers to perform the operations of any of Examples 1 to 10.

Example 13 may include a method for performing the operations of any of Examples 1 to 10.

Example 14 may include an apparatus including logic, modules, or circuitry to perform one or more elements of the operations described in or related to any of Examples 1-10, or any other operations or process described herein.

Example 15 may include a method, technique, or process as described in or related to the operations of any of Examples 1-10, or portions or parts thereof.

Example 16 may include an apparatus, e.g., a user equipment, including: one or more processors and one or more computer-readable media including instructions that, when executed by the one or more processors, cause the one or more processors to perform the method, techniques, or process as described in or related to the operations of any of Examples 1-10, or portions thereof.

Example 17 may include a computer program including instructions, where execution of the program by a processing element is to cause the processing element to carry out the operations of any of Examples 1-10, or portions thereof. The operations or actions performed by the instructions executed by the processing element can include the operations of any one of Examples 1-10.

Example 18 may include a method of communicating in a wireless network as shown and described herein.

Example 19 may include a system for providing wireless communication as shown and described herein. The operations or actions performed by the system can include the operations of any one of Examples 1-10.

Example 20 may include a device for providing wireless communication as shown and described herein. The operations or actions performed by the device can include the operations of any one of Examples 1-10.

The previously-described operations of Examples 1-10 are implementable using a computer-implemented method; a non-transitory, computer-readable medium storing computer-readable instructions to perform the computer-implemented method; and a computer system including a computer memory interoperably coupled with a hardware processor configured to perform the computer-implemented method or the instructions stored on the non-transitory, computer-readable medium.

Any of the above-described examples may be combined with any other example (or combination of examples), unless explicitly stated otherwise. The foregoing description of one or more implementations provides illustration and description, but is not intended to be exhaustive or to limit the scope of embodiments to the precise form disclosed. Modifications and variations are possible in light of the above teachings or may be acquired from practice of various embodiments.

Although the embodiments above have been described in considerable detail, numerous variations and modifications will become apparent to those skilled in the art once the above disclosure is fully appreciated. It is intended that the following claims be interpreted to embrace all such variations and modifications.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

1. One or more processors of a user equipment (UE), the one or more processors configured to cause the UE to perform operations comprising:
generating a plurality of codewords for simultaneous uplink transmission via at least one antenna panel of the UE, wherein the plurality of codewords are associated with a scheduled physical uplink shared channel (PUSCH) transmission occasion;
initializing, based on a number of the plurality of codewords, a respective scrambling sequence generator for each of the plurality of codewords;
generating, using the respective scrambling sequence generator, a respective scrambling sequence for scrambling the plurality of codewords; and
scrambling the plurality of codewords using the respective scrambling sequence.

2. The one or more processors of claim 1, wherein the UE is served by a base station, and wherein the operations further comprise:
transmitting, using RF circuitry, at least one PUSCH transmission to the base station via the at least one antenna panel, wherein the at least one PUSCH transmission comprises the scrambled plurality of codewords.

3. The one or more processors of claim 2, wherein transmitting the at least one PUSCH transmission to the base station via the at least one antenna panel comprises:
transmitting, using the RF circuitry, a first PUSCH transmission to a first transmission/reception point (TRP) of the base station via a first antenna panel, the first PUSCH transmission comprising a first codeword; and
transmitting, using the RF circuitry, a second PUSCH transmission to a second TRP of the base station via a second antenna panel, the second PUSCH transmission comprising a second codeword.

4. The one or more processors of claim 1, wherein initializing the respective scrambling sequence generator comprises generating an initialization code based on the number of the plurality of codewords.

5. The one or more processors of claim 4, wherein the initialization code comprises:
$${c}_{i n i t} = {n}_{RNTI} \cdot {2}^{15} + q \cdot {2}^{14} + {n}_{ID} ,$$
where q is the number of the plurality of codewords, where n_{RNTI} is a Radio Network Temporary Identifier (RNTI) associated with the PUSCH transmission occasion, and where n_{ID} is a higher layer parameter.

6. The one or more processors of claim 4, wherein generating the initialization code is further based on a parameter received from a base station via higher layer signaling.

7. The one or more processors of claim 1, the operations further comprising:
receiving a single Downlink Control Information (DCI) scheduling a plurality of PUSCH transmissions in the PUSCH transmission occasion, wherein the plurality of PUSCH transmissions overlap in at least one of time or frequency.

8. The one or more processors of claim 1, the operations further comprising:
receiving a plurality of Downlink Control Information (DCI) scheduling a plurality of PUSCH transmissions in the PUSCH transmission occasion, wherein the plurality of PUSCH transmissions overlap in at least one of time or frequency.

9. The one or more processors of claim 1, wherein a plurality of PUSCH transmissions are scheduled in the PUSCH transmission occasion, and wherein the plurality of PUSCH transmissions are repetitions of a same transport block.

10. The one or more processors of claim 1, wherein a plurality of PUSCH transmissions are scheduled in the PUSCH transmission occasion, and wherein the plurality of PUSCH transmissions comprise different portions of a same transport block.

11. (canceled)

12. (canceled)

13. (canceled)

14. A method comprising:
generating a plurality of codewords for simultaneous uplink transmission via at least one antenna panel of a user equipment (UE), wherein the plurality of codewords are associated with a scheduled physical uplink shared channel (PUSCH) transmission occasion;
initializing, based on a number of the plurality of codewords, a scrambling sequence generator for the plurality of codewords;
generating, using the scrambling sequence generator, a respective scrambling sequence for scrambling the plurality of codewords; and
scrambling the plurality of codewords using the respective scrambling sequence.

15. The method of claim 14, wherein the UE is served by a base station, and wherein the method further comprises:
transmitting, using RF circuitry, at least one PUSCH transmission to the base station via the at least one antenna panel, wherein the at least one PUSCH transmission comprises the scrambled plurality of codewords.

16. The method of claim 15, wherein transmitting the at least one PUSCH transmission to the base station via the at least one antenna panel comprises:
transmitting, using the RF circuitry, a first PUSCH transmission to a first transmission/reception point (TRP) of the base station via a first antenna panel, the first PUSCH transmission comprising a first codeword; and
transmitting, using the RF circuitry, a second PUSCH transmission to a second TRP of the base station via a second antenna panel, the second PUSCH transmission comprising a second codeword.

17. The method of claim 14, wherein initializing the scrambling sequence generator comprises generating an initialization code based on the number of the plurality of codewords.

18. The method of claim 17, wherein the initialization code comprises:
$${c}_{i n i t} = {n}_{RNTI} \cdot {2}^{15} + q \cdot {2}^{14} + {n}_{ID} ,$$
where q is the number of the plurality of codewords, where n_{RNTI} is a Radio Network Temporary Identifier (RNTI) associated with the PUSCH transmission occasion, and where n_{ID} is a higher layer parameter.

19. The method of claim 17, wherein generating the respective initialization code is further based on a parameter received from a base station via higher layer signaling.

20. The method of claim 14, the method further comprising:
receiving a single Downlink Control Information (DCI) scheduling a plurality of PUSCH transmissions in the PUSCH transmission occasion, wherein the plurality of PUSCH transmissions overlap in at least one of time or frequency.

21. A user equipment (UE) comprising:
a radio frequency (RF) circuitry;
one or more processors communicatively coupled to the RF circuitry, the one or more processors configured to perform operations composing:
generating a plurality of codewords for simultaneous uplink transmission via at least one antenna panel, wherein the plurality of codewords are associated with a scheduled physical uplink shared channel (PUSCH) transmission occasion;
initializing, based on a number of the plurality of codewords, a scrambling sequence generator for the plurality of codewords;
generating, using the scrambling sequence generator, a respective scrambling sequence for scrambling the plurality of codewords; and
scrambling the plurality of codewords using the respective scrambling sequence.

22. The UE of claim 21, wherein the operations further comprise:
transmitting, using RF circuitry, at least one PUSCH transmission to a base station via the at least one antenna panel, wherein the at least one PUSCH transmission comprises the scrambled plurality of codewords.

23. The UE of claim 21, wherein transmitting the at least one PUSCH transmission via the at least one antenna panel comprises:
transmitting, using the RF circuitry, a first PUSCH transmission to a first transmission/reception point (TRP) via a first antenna panel, the first PUSCH transmission comprising a first codeword; and
transmitting, using the RF circuitry, a second PUSCH transmission to a second TRP via a second antenna panel, the second PUSCH transmission comprising a second codeword.
